(19) United States
(12) Patent Application Publication
(10) Pub. No.: US 2022/0067611 A1
(43) Pub. Date: Mar. 3, 2022

(54) LEARNING-BASED RESOURCE ALLOCATION METHOD, LEARNING-BASED RESOURCE ALLOCATION SYSTEM AND USER INTERFACE

(71) Applicant: INDUSTRIAL TECHNOLOGY RESEARCH INSTITUTE, HSINCHU (TW)

(72) Inventors: Tung-Han WU, Taichung City (TW); Tsung-Jung HSIEH, Tainan City (TW)

(73) Assignee: INDUSTRIAL TECHNOLOGY RESEARCH INSTITUTE, HSINCHU (TW)

(21) Appl. No.: 17/077,851

(22) Filed: Oct. 22, 2020

(30) Foreign Application Priority Data
Aug. 27, 2020 (TW) 109129269

(51) Int. Cl. G06Q 10/06; G06Q 10/08; G06Q 10/04; G06N 20/00

(52) U.S. Cl. CPC G06Q 10/06315; G06Q 10/087; G06Q 50/04; G06N 20/00; G06Q 10/04

(57) ABSTRACT

A learning-based resource allocation method, a learning-based resource allocation system and a user interface are provided. The learning-based resource allocation method includes following steps. Several setting contents of several resources applicable to several batch number products are obtained from an available resource database. Several resource allocation solutions are obtained. Each of the resource allocation solutions is a combination of the batch number products and the setting contents and is classified in an excellent group or an inferior group. The setting contents corresponding to a first part of the resource allocation solutions belonging to the inferior group are changed using a first algorithm, and the setting contents corresponding to a second part of the resource allocation solutions belonging to the inferior group are changed using a second algorithm different from the first algorithm. An optimal resource allocation solution is obtained according to the resource allocation solutions which are updated.

This application claims the benefit of Taiwan application Serial No. 109129269, filed Aug. 27, 2020, the disclosure of which is incorporated by reference herein in its entirety.

### TECHNICAL FIELD

The disclosure relates in general to a learning-based resource allocation method, a learning-based resource allocation system and a user interface.

### BACKGROUND

Along with the rapid development in culture and economy, supply chains have become an inextricable part in the industries. The industries are facing problems of the logistics time being too lengthy, the outsourcing system lacking an efficient management mode, and the supply chains having scheduling difficulty due to the multi-plant or multi-equipment arrangement. Currently, the feedback of production progress in the supply chains still depends on manual control, and therefore is inaccurate and cannot be provided in a real-time manner. Besides, abnormalities are complicated and hard to resolve. Therefore, resource allocation is getting more and more important.

The allocation of production resources is a non-deterministic polynomial-time hardness (NP Hard) problem. Many research personnel used to resolve the above problems using one single algorithm, such as the multi-objective algorithm. However, the multi-objective algorithm has a low convergence speed, and takes more computing time to obtain an optimal solution.

### SUMMARY

The disclosure is directed to a learning-based resource allocation method, a learning-based resource allocation system and a user interface.

According to one embodiment, a learning-based resource allocation method is provided. The learning-based resource allocation method includes the following steps. Several setting contents of several resources applicable to several batch number products are obtained from an available resource database. Several resource allocation solutions are obtained. Each of the resource allocation solutions is a combination of the batch number products and the setting contents and is classified in an excellent group or an inferior group. The setting contents corresponding to a first part of the resource allocation solutions belonging to the inferior group are changed using a first algorithm. The setting contents corresponding to a second part of the resource allocation solutions belonging to the inferior group are changed using a second algorithm. The first algorithm is different from the second algorithm. An optimal resource allocation solution is obtained according to the resource allocation solutions which are updated.

According to another embodiment, a learning-based resource allocation system is provided. The learning-based resource allocation system includes a data acquisition device, a knowledge learning device and an output device. The data acquisition device includes an available resource database and an allocation unit. The available resource database records several setting contents of several resources applicable to several batch number products. The allocation unit is configured to obtain several resource allocation solutions. Each of the resource allocation solutions is a combination of the batch number products and the setting contents. Each of the resource allocation solutions is classified in an excellent group or an inferior group. The knowledge learning device includes a first calculation unit and a second calculation unit. The first calculation unit is configured to change the setting contents a first part of the resource allocation solutions belonging to the inferior group using a first algorithm. The second calculation unit is configured to change the setting contents corresponding to a second part of the resource allocation solutions belonging to the inferior group using a second algorithm. The first algorithm is different from the second algorithm. The output device is configured to obtain an optimal resource allocation solution is obtained according to the resource allocation solutions which are updated.

According to an alternative embodiment, a user interface is provided. The user interface includes a parameter setting window, a resource allocation result window and a resource allocation suggestion window. The parameter setting window is configured to select an available resource database, which records several setting contents of several resources applicable to several batch number products. The resource allocation result window is configured to output an optimal resource allocation solution, which is a combination of the batch number products and the setting contents. The resource allocation suggestion window is configured to output a heat map, which records the number of times of positive improvements of the resources when several resource allocation solutions are changed.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of field situations according to an embodiment.

FIG. 2 is a block diagram of a learning-based resource allocation system according to an embodiment.

FIG. 3 is a flowchart of a learning-based resource allocation method according to an embodiment.

FIG. 4 is a schematic diagram of 10 resource allocation solutions.

FIG. 5 is a schematic diagram of a first algorithm according to an embodiment.

FIG. 6 is a schematic diagram of a second algorithm according to an embodiment.

FIG. 7 is an update operation of Q matrix according to an embodiment.

FIG. 8 is a heat map of a forging mold according to an embodiment.

FIG. 9 is a user interface for learning-based allocation of resources according to an embodiment.

FIG. 10 is a curve diagram illustrating a comparison between the curve of a learning-based allocation method of the present disclosure and the curve of a conventional learning-based allocation method.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

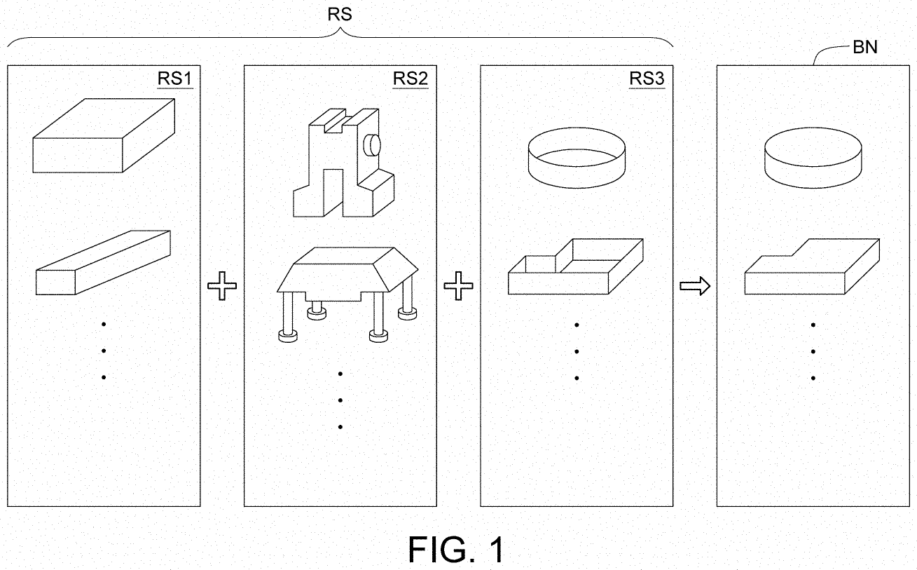

Referring to FIG. 1, a schematic diagram of field situations according to an embodiment is shown. Let the steel industry be taken for example. The resources RS that need to be allocated to each of the batch number products BN of steel include an ingot RS1, a forging machine RS2, and a mold RS3 (the mold for forging steel). The ingot RS1, the forging machine RS2, and the mold RS3 respectively have several options. As indicated in Table 1, the ingot RS1 may include different numbers such as “1, 2, 3, . . . ” The forging machine RS2 may include different numbers such as “1, 2, 3, . . . ” The mold RS3 may include different numbers such as “11, 12, 32, . . . ” The steel with the same batch number product BN could be manufactured according to the setting contents SC of the resources RS. For example, different setting contents SC may incur different costs and may generate different quantities of leftover. The purpose of resource allocation in the steel industry is for obtaining an optimal or a preferred resource allocation solution, which minimizes or reduces the manufacturing cost and leftover.

TABLE 1

| | | Resource RS | | | |
|---|---|---|---|---|---|
| Batch | | | Forging | | |
| number | Setting | | machine | | |
| product BN | content SC | Ingot RS1 | RS2 | Mold RS3 | . . . |
| 7 | 1 | 1 | 1 | 11 | . . . |
| 7 | 2 | 1 | 1 | 12 | . . . |
| . | . | . | . | . | . |
| . | . | . | . | . | . |
| . | . | . | . | . | . |
| 7 | 8 | 3 | 1 | 12 | . . . |
| . | . | . | . | . | . |
| . | . | . | . | . | . |
| . | . | . | . | . | . |
| 40 | 1 | 1 | 1 | 11 | . . . |
| . | . | . | . | . | . |
| . | . | . | . | . | . |
| . | . | . | . | . | . |
| 40 | 4 | 2 | 3 | 32 | . . . |

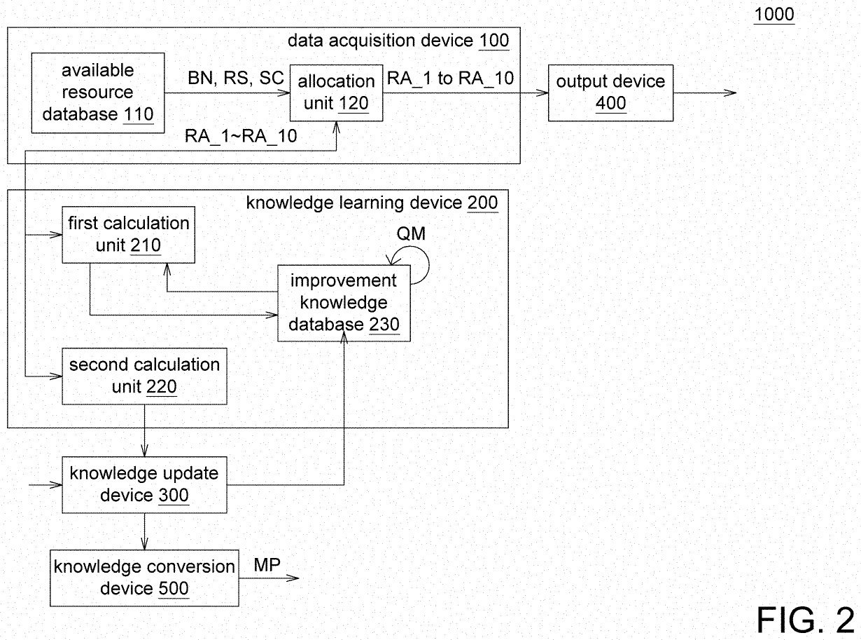

Referring to FIG. 2, a block diagram of a learning-based resource allocation system 1000 according to an embodiment is shown. The learning-based resource allocation system 1000 includes a data acquisition device 100, a knowledge learning device 200, a knowledge update device 300, an output device 400 and a knowledge conversion device 500. The data acquisition device 100, the knowledge learning device 200, the knowledge update device 300, the output device 400 and the knowledge conversion device 500 can be realized by such as a circuit, a chip, a circuit board or a storage device storing a number of programming codes. The function of each element is disclosed below. The data acquisition device 100 is configured to acquire necessary calculation information. The data acquisition device 100 includes an available resource database 110 and an allocation unit 120. The knowledge learning device 200 is configured to perform machine learning to optimize resource allocation. The knowledge learning device 200 includes a first calculation unit 210, a second calculation unit 220 and an improvement knowledge database 230. The knowledge update device 300 is configured to update the information during the machine learning process, such that machine learning can gradually converge. The output device 400 is configured to output information. The knowledge conversion device 500 is configured to convert abstract information generated during the machine learning process into concrete information.

The learning-based resource allocation system 1000 can perform two machine learning algorithms through the knowledge learning device 200 to improve the efficiency of machine learning. Additionally, the learning-based resource allocation system 1000 can provide concrete information through the knowledge conversion device 500 as a reference for the operator to perform resource allocation. The calculations of each of the above elements are disclosed below with an accompanying flowchart.

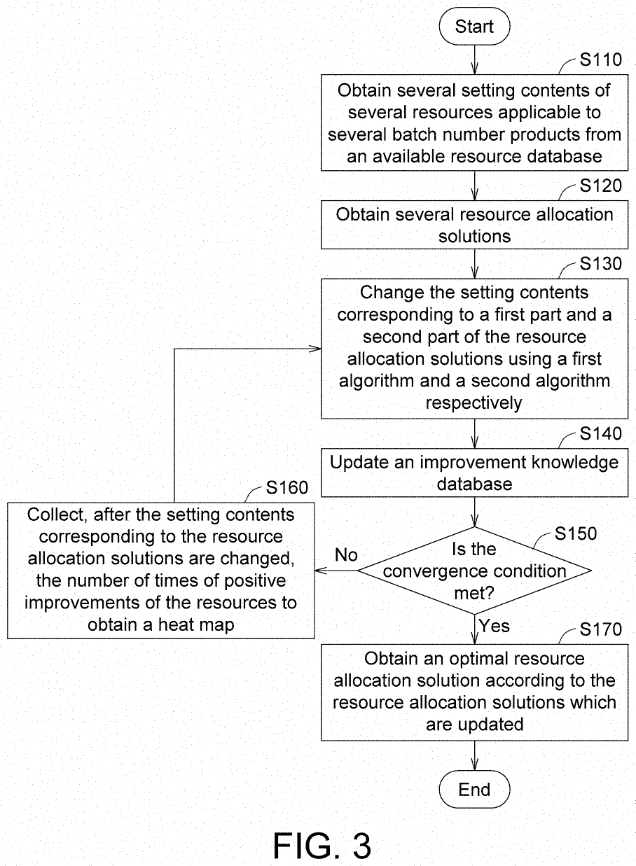

Referring to FIG. 3, a flowchart of a learning-based resource allocation method according to an embodiment is shown. Firstly, the method begins at step S110, the setting contents SC of the resources RS applicable to the batch number products BN as indicated in Table 1 are obtained from the available resource database 110 of the data acquisition device 100. In the present step, the data acquisition device 100 continuously receives the message of the resources applicable to one or more production lines to create the available resource database 110. For example, the data acquisition device 100 can access the message in a field database system or an enterprise resource planning (ERP) system to create the available resource database 110.

Next, the method proceeds to step S120, several resource allocation solutions (such as resource allocation solutions RA_1 to RA_10) are obtained by the allocation unit 120 of the data acquisition device 100. Each of the resource allocation solutions RA_1 to RA_10 is a combination of the batch number products BN and the setting contents SC. Refer to Table 2, setting contents corresponding to the resource allocation solution RA_1 are shown. In initial, the resource allocation solution RA_1, the setting content SC corresponding to each of the batch number products BN is randomly selected. In the resource allocation solution RA_1 of Table 2, a fifth setting content SC corresponding to the 1^{st} batch number product BN is randomly selected, a 2^{nd} setting content SC corresponding to the second batch number product BN is randomly selected, an 8-th setting content SC corresponding to the 3^{rd} batch number product BN is randomly selected, and the rest can be obtained by the same analogy.

TABLE 2

| | | Batch number product BN | | | | | |
|---|---|---|---|---|---|---|---|
| | | 1 | 2 | 3 | . . . | . . . | 284 |
| Setting content SC | | 5 | 2 | 8 | . . . | . . . | 6 |
| Resource | Ingot RS1 | 2 | 1 | 3 | . . . | . . . | 1 |
| RS | Forging | 1 | 3 | 2 | . . . | . . . | 2 |
| | machine | | | | | | |
| | RS2 | | | | | | |
| | Forging | 12 | 32 | 11 | . . . | . . . | 12 |
| | mold RS3 | | | | | | |
| | . . . | . . . | . . . | . . . | . . . | . . . | . . . |

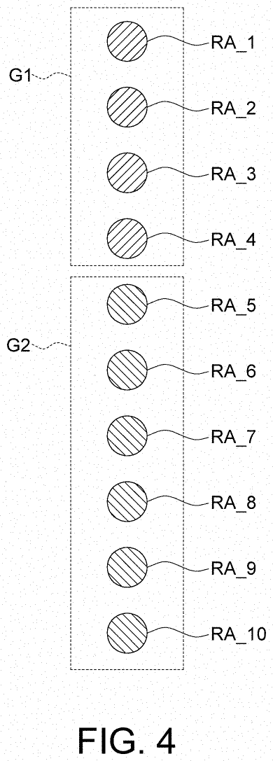

Referring to FIG. 4, 10 resource allocation solutions RA_1 to RA_10 are exemplified. Each of the resource allocation solutions RA_1 to RA_10 is classified in an excellent group G1 or an inferior group G2. As indicated in FIG. 4, the resource allocation solutions RA_1 to RA_4 are classified in the excellent group G1, and the resource allocation solutions RA_5 to RA_10 are classified in the inferior group G2. The allocation unit 120 sorts the 10 resource allocation solutions RA_1 to RA_10 in an order of cost. Then, the allocation unit 120 classifies the 10 resource allocation solutions RA_1 to RA_10 in the excellent group G1 or the inferior group G2 according to a specific threshold value.

After the resource allocation solutions RA_1 to RA_10 are obtained, the setting contents SC corresponding to the resource allocation solutions RA_5 to RA_10 belonging to the inferior group G2 are optimized.

Then, the method proceeds to step S130, the setting contents SC corresponding to a first part (such as resource allocation solutions RA_5 to RA_6) of the resource allocation solutions RA_5 to RA_10 belonging to the inferior group G2 are changed by a first calculation unit 210 of the knowledge learning device 200 using a first algorithm, and the setting contents SC corresponding to a second part (such as resource allocation solutions RA_7 to RA_10) of the resource allocation solutions RA_5 to RA_10 belonging to the inferior group G2 are changed by a second calculation unit 220 of the knowledge learning device 200 using a second algorithm. The first algorithm is different from the second algorithm. In the present step, the setting contents SC corresponding to all resource allocation solutions RA_5 to RA_10 belonging to the inferior group G2 are changed.

In the present embodiment, the knowledge learning device 200 performs the first algorithm and the second algorithm by way of collaborative learning.

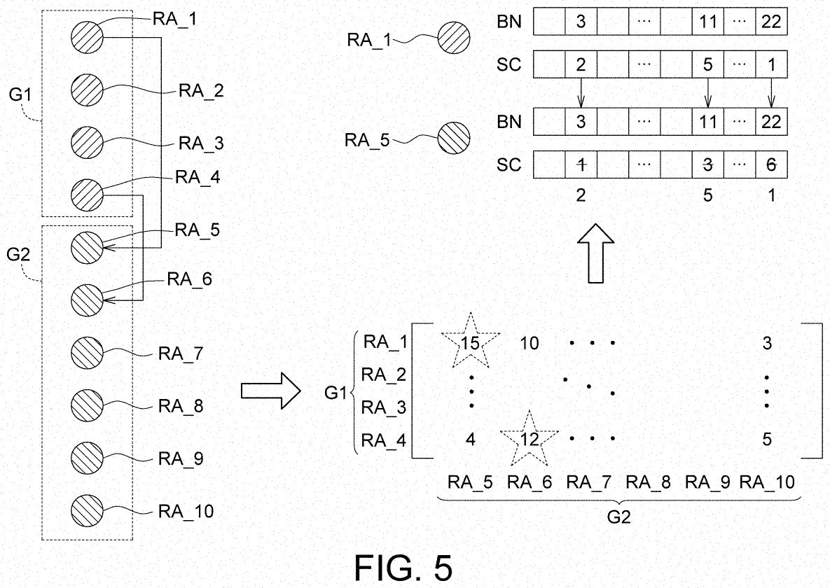

Referring to FIG. 5, a schematic diagram of a first algorithm according to an embodiment is shown. The first algorithm is a re-enforce learning algorithm (RL algorithm), such as a Q learning algorithm or a sarsa algorithm. The re-enforce learning algorithm can accumulate the optimization experience to increase the converging speed. As indicated in FIG. 5, the improvement knowledge database 230 records a Q matrix QM. In the Q matrix, the Q value QV records the degree of improvement after the resource allocation solutions RA_5 to RA_10 belonging to the inferior group G2 are updated with reference to the resource allocation solutions RA_1 to RA_4 belonging to the excellent group G1.

The Q value QV is obtained according to the following formula (1):

$$QV = \{ \begin{matrix}F ( {{w}^{′}}_{m} - {w}_{m} ) \\ 0\end{matrix} \begin{matrix}if F ( {{w}^{′}}_{m} - {w}_{m} ) > 0 \\ if F ( {{w}^{′}}_{m} - {w}_{m} ) \leq 0\end{matrix} \qquad ( 1 )$$

Wherein, wₘ represents an original setting content SC, w′ₘ, represents an updated setting content SC, and F(w′ₘ-wₘ) represents the degree of improvement.

In terms of the resource allocation solution RA_5, the largest Q value QV (marked by stars) corresponds to the resource allocation solution RA_1. That is, in terms of the resource allocation solution RA_5, the largest degree of improvement can be obtained if the setting contents are changed with reference to the resource allocation solution RA_1.

Then, the first calculation unit 210 randomly selects N batch number products BN (such as the 3^{rd} batch number product BN, the 11-th batch number product BN, and the 22^{nd} batch number product BN), and changes the setting contents SC corresponding to the resource allocation solution RA_5 with reference to the setting contents SC corresponding to the resource allocation solution RA_1.

Similarly, in terms of the resource allocation solutions RA_6, the largest degree of improvement can be obtained if the setting contents are changed with reference to the resource allocation solution RA_4.

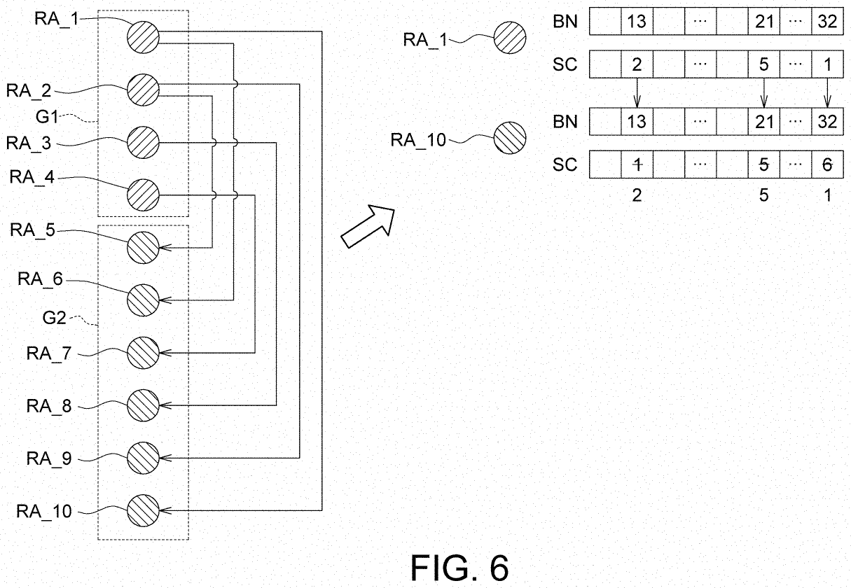

Referring to FIG. 6, a schematic diagram of a second algorithm according to an embodiment is shown. The second algorithm is an evolutionary algorithm (EA), which considers all possible solutions and makes the learning process converge to the global optimal solution. The second algorithm does not consider the Q matrix QM (illustrated in FIG. 5) but changes the setting contents SC according to a predetermined order. Let FIG. 6 be taken for example. The allocation starts with the worst resource allocation solution RA_10 and changes the setting contents corresponding to the resource allocation solution RA_10 with reference to the resource allocation solution RA_1. In terms of the resource allocation solution RA_9, the setting contents are changed with reference to the resource allocation solution RA_2. In terms of the resource allocation solution RA_8, the setting contents are changed with reference to the resource allocation solution RA_3. In terms of the resource allocation solution RA_7, the setting contents are changed with reference to the resource allocation solution RA_4. In terms of the resource allocation solution RA_6, the setting contents are changed with reference to the resource allocation solution RA_1. In terms of the resource allocation solution RA_5, the setting contents are changed with reference to the resource allocation solution RA_2. All of the resource allocation solutions RA_5 to RA_10 in the inferior group G2 are changed.

After the setting contents SC corresponding to the resource allocation solutions RA_5 to RA_10 are changed, the resource allocation solutions RA_1 to RA_10 are re-sorted. For example, the resource allocation solution RA_5 may ascend by an order and be classified in the excellent group G1, the resource allocation solutions RA_4 may descend by one order and be classified in the inferior group G2. In the next calculation, only the setting contents SC corresponding to the resource allocation solutions RA_4, RA_6 to RA_10 belonging to the inferior group G2 are changed.

The second algorithm is the evolutionary algorithm which is mainly for enabling the learning process to be converged to the global optimal solution but has a slow converging speed. The first algorithm is the re-enforce learning algorithm, which is capable of accumulating the optimization experience to increase the converging speed but may converge to a local optimal solution. The resource allocation method of the present disclosure uses both the first algorithm and the second algorithm, and therefore possesses the strengths of both algorithms, not only enabling the learning process to converge to the global optimal solution, but also increasing the converging speed.

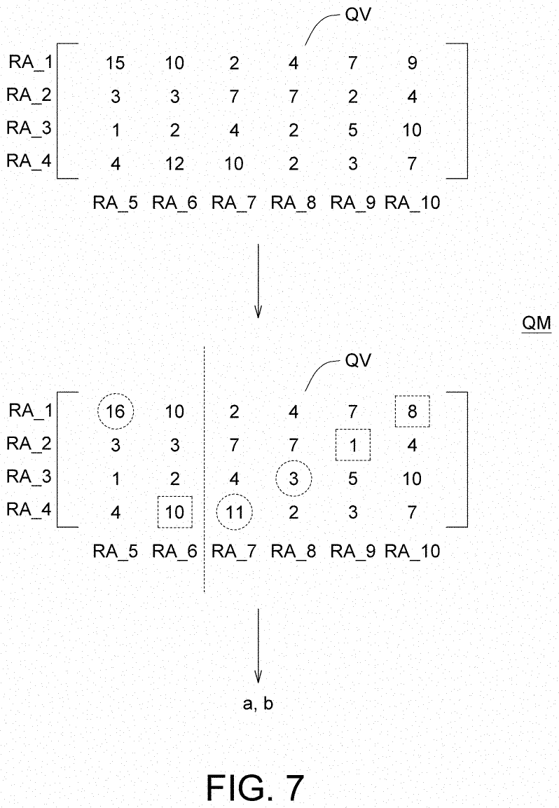

Then, the method proceeds to step S140, the Q matrix QM in the improvement knowledge database 230 is updated so that the first algorithm can be performed again. Regardless of the setting contents corresponding to the resource allocation solutions RA_5 to RA_10 being changed using the first algorithm or the second algorithm, corresponding values in the Q matrix QM are updated. Referring to FIG. 7, an update operation of Q matrix QM according to an embodiment is shown. Since there are 6 resource allocation solutions RA_5 to RA_10 belonging to the inferior group G2, correspondingly 6Q values QV in the Q matrix QM need to be updated. If the Q value QV increases (such as the dotted circles), the change is defined as a positive improvement; conversely, if the Q value QV decreases (such as the dotted squares), the change is defined as a negative improvement. As indicated in FIG. 7, the first number a of positive improvement of the resource allocation solutions RA_5 to RA_6 using the first algorithm is 1, and the second number b of positive improvement of the resource allocation solutions RA_7 to RA_10 using the first algorithm is 2.

In the above calculation, the resource allocation solutions RA_5 to RA_6 belonging to the inferior group G2 use the first algorithm, and the resource allocation solutions RA_7 to RA_10 belonging to the inferior group G2 use the second algorithm. That is, the ratio of the first part to the second part is 2:4. In an embodiment, the ratio of the first part to the second part can be gradually adjusted. The first part and the second part can be adjusted according to the first number a of positive improvement of the resource allocation solutions using the first algorithm and the second number b of positive improvement of the resource allocation solutions using the second algorithm. For example, the first part and the second part can be adjusted according to the ratio of 1/a:1/b. Given that the first number a of positive improvement is 1 and the second number b of positive improvement is 2, the ratio of the first part to the second part is adjusted to be 1/1:1/2=2:1. Next time when the first algorithm and the second algorithm are performed, the resource allocation solutions RA_5 to RA_8 belonging to the inferior group G2 will use the first algorithm, and the resource allocation solutions RA_9 to RA_10 belonging to the inferior group G2 will use the second algorithm.

Then, the method proceeds to step S150, whether the convergence condition is met is determined. The convergence condition is, for example, the cost reduction in the optimal resource allocation solution RA_1 is lower than a predetermined value. If the convergence condition is met, then the method proceeds to step S170; otherwise, the method proceeds to step S160 and returns to step S130, the calculation is performed again (in an embodiment, step S160 can be omitted and the method directly returns to step S130).

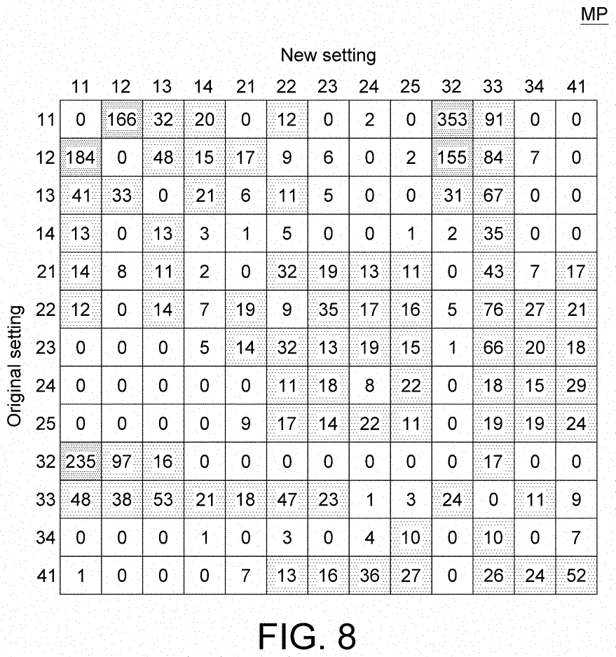

In step S160, after the setting contents SC corresponding to the resource allocation solutions RA_1 to RA_10 are changed, statistics of the number of times of positive improvements of the resources RS are collected by the knowledge conversion device 500 to obtain a heat map (such as the heat map MP of FIG. 8). Referring to FIG. 8, a heat map MP of a forging mold RS3 according to an embodiment is shown. In above calculations, when the setting contents SC corresponding to the resource allocation solutions RA_1 to RA_10 are changed and generate positive improvements, the number of times is accumulated in the heat map MP. As indicated in FIG. 8, the number of times of change from the No. 11 forging mold RS3 to the No. 32 forging mold RS3 is the largest, therefore the operator will receive a suggestion: “changing the No. 11 forging mold RS3 to the No. 32 forging mold RS3 normally result in a better improvement.”

As indicated in the heat map MP of FIG. 8, several frequency intervals are represented using different colors, so that the operator can identify which change results in better improvement at a glance.

Then, the method proceeds to step S170, an optimal resource allocation solution is obtained by the output device 400 according to the resource allocation solutions RA_1 to RA_10 which are updated. After the setting contents SC corresponding to the resource allocation solutions RA_1 to RA_10 are changed, the performances of the resource allocation solutions are no longer ranked in a descending order from the resource allocation solution RA_1 to the resource allocation solution RA_10. Meanwhile, the outputted optimal resource allocation solution is the first resource allocation solution outputted according to the last ranking result.

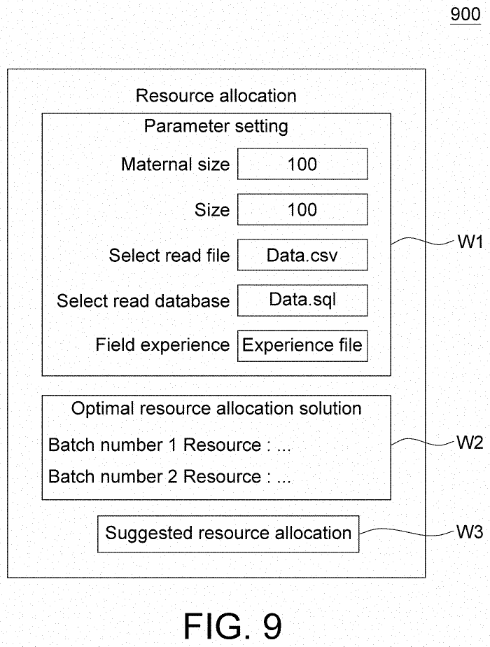

Referring to FIG. 9, a user interface 900 for learning-based allocation of resources according to an embodiment is shown. The user interface 900 includes a parameter setting window W1, a resource allocation result window W2 and a resource allocation suggestion window W3. The parameter setting window W1 is configured to select an available resource database 110, which records the setting contents SC of the resources RS applicable to the batch number products BN. The resource allocation result window W2 is configured to output an optimal resource allocation solution, which is a combination of the batch number products BN and the setting contents SC. The resource allocation suggestion window W3 is configured to display the heat map MP on another page. The heat map MP records the number of times of positive improvements of the resources RS when the resource allocation solutions RA_1 to RA_10 are changed.

Referring to Table 3, cost changes in a steel factory using the present embodiment are shown. The cost changes show that the learning-based allocation method of the present disclosure significantly reduces the cost.

TABLE 3

| | Cost (NTD) |
|---|---|
| Current state | 4.146574e+06 |
| After using the present | 3.44497e+06 |
| embodiment | |

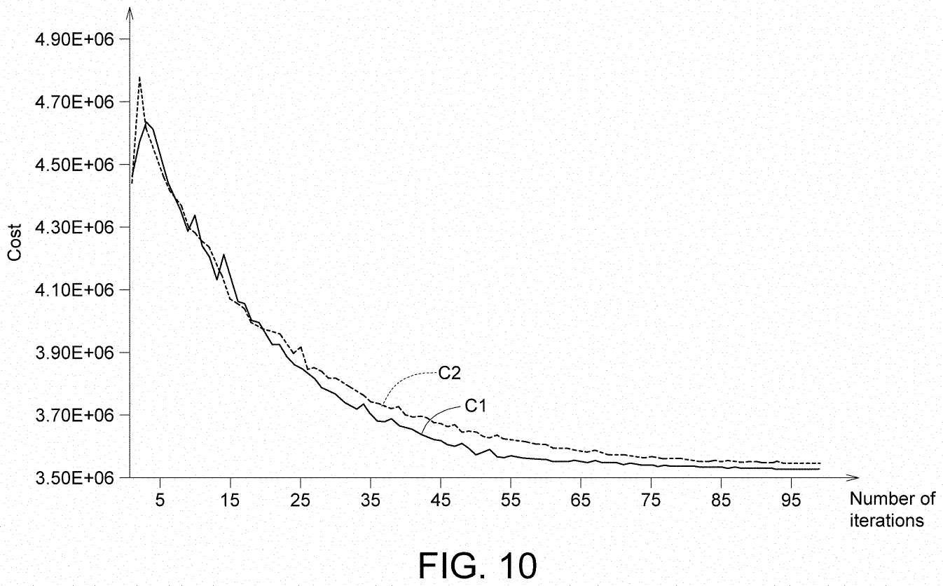

Referring to FIG. 10, a curve diagram illustrating a comparison between the curve of a learning-based allocation method of the present disclosure and the curve of a conventional learning-based allocation method is shown. Curve C1 illustrates the cost change generated when both the first algorithm and the second algorithm are used according to the present embodiment. Curve C2 illustrates the cost change generated when only the second algorithm is used according to the conventional method. As indicated in FIG. 10, after 25 iterations, curve C1 is significantly lower than curve C2. Therefore, the learning-based allocation method of the present embodiment can quickly converge and is applicable to the production lines.

According to the above embodiments, the learning-based allocation method and the learning-based resource allocation system 1000 using the same can perform two machine learning algorithms to increase the efficiency of machine learning. Besides, the heat map MP can provide concrete information as a reference for the operator to perform resource allocation.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A learning-based resource allocation method, comprising:
obtaining a plurality of setting contents of a plurality of resources applicable to a plurality of batch number products from an available resource database;
obtaining a plurality of resource allocation solutions, wherein each of the resource allocation solutions is a combination of the batch number products and the setting contents and is classified in an excellent group or an inferior group;
changing the setting contents corresponding to a first part of the resource allocation solutions belonging to the inferior group using a first algorithm, and changing the setting contents corresponding to a second part of the resource allocation solutions belonging to the inferior group using a second algorithm different from the first algorithm; and
obtaining an optimal resource allocation solution according to the resource allocation solutions which are updated.

2. The learning-based resource allocation method according to claim 1, wherein all of the resource allocation solutions belonging to the inferior group are changed.

3. The learning-based resource allocation method according to claim 2, wherein the setting contents corresponding to the resource allocation solutions belonging to the inferior group are changed with reference to one of the resource allocation solutions belonging to the excellent group.

4. The learning-based resource allocation method according to claim 3, further comprising:
collecting, after the setting contents corresponding to the resource allocation solutions are changed, number of times of positive improvements of the resources to obtain a heat map.

5. The learning-based resource allocation method according to claim 2, wherein the first algorithm, being a re-enforce learning algorithm (RL algorithm), changes the setting contents according to a best improvement in an improvement knowledge database.

6. The learning-based resource allocation method according to claim 5, further comprising:
updating the improvement knowledge database.

7. The learning-based resource allocation method according to claim 1, wherein the second algorithm, being an evolutionary algorithm (EA), changes the setting contents in a predetermined order.

8. The learning-based resource allocation method according to claim 1, wherein a ratio of the first part to the second part is gradually adjusted.

9. The learning-based resource allocation method according to claim 8, wherein the first part and the second part are adjusted according to a first number of positive improvement using the first algorithm and a second number of positive improvement using the second algorithm respectively.

10. A learning-based resource allocation system, comprising:
a data acquisition device, comprising:
an available resource database, which records a plurality of setting contents of a plurality of resources applicable to a plurality of batch number products; and
an allocation unit configured to obtain a plurality of resource allocation solutions, wherein each of the resource allocation solutions is a combination of the batch number products and the setting contents and is classified in an excellent group or an inferior group;
a knowledge learning device, comprising:
a first calculation unit configured to change the setting contents corresponding to a first part of the resource allocation solutions belonging to the inferior group using a first algorithm; and
a second calculation unit configured to change the setting contents corresponding to a second part of the resource allocation solutions belonging to the inferior group using a second algorithm different from the first algorithm; and
an output device configured to obtain an optimal resource allocation solution according to the resource allocation solutions which are updated.

11. The learning-based resource allocation system according to claim 10, wherein all of the resource allocation solutions belonging to the inferior group are changed.

12. The learning-based resource allocation system according to claim 11, wherein the setting contents corresponding to each of the resource allocation solutions belonging to the inferior group are changed with reference to one of the resource allocation solutions belonging to the excellent group.

13. The learning-based resource allocation system according to claim 12, further comprising:
a knowledge conversion device configured to collect, after the setting contents corresponding to the resource allocation solutions are changed, number of times of positive improvements of the resources to obtain a heat map.

14. The learning-based resource allocation system according to claim 11, wherein the first algorithm, being a re-enforce learning algorithm (RL algorithm), changes the setting contents according to a best improvement in an improvement knowledge database.

15. The learning-based resource allocation system according to claim 14, further comprising:
a knowledge update device configured to update the improvement knowledge database.

16. The learning-based resource allocation system according to claim 10, wherein the second algorithm, being an evolutionary algorithm (EA), changes the setting contents in a predetermined order.

17. The learning-based resource allocation system according to claim 10, wherein a ratio of the first part to the second part is gradually adjusted.

18. The learning-based resource allocation system according to claim 17, wherein the first part and the second part are adjusted according to a first number of positive improvement and a second number of positive improvement using the first algorithm and the second algorithm respectively.

19. A user interface, comprising:
a parameter setting window configured to select an available resource database, which records a plurality of setting contents of a plurality of resources applicable to a plurality of batch number products;
a resource allocation result window configured to output an optimal resource allocation solution according to a plurality of resource allocation solutions, each of which is a combination of the batch number products and the setting contents; and
a resource allocation suggestion window configured to output a heat map, which records number of times of positive improvements of the resources when the resource allocation solutions are changed.

20. The user interface according to claim 19, wherein the heat map represents a plurality of frequency intervals using different colors.
